(19) United States
(12) Patent Application Publication
(10) Pub. No.: US 2026/0368110 A1
(43) Pub. Date: Nov. 19, 2026

(54) VIRTUALIZED SIDEBAND BUS WITHIN MEMORY SYSTEM

(71) Applicant: Micron Technology, Inc., Boise, ID (US)

(72) Inventors: Lance W. Dover, Fair Oaks, CA (US); Frank F. Ross, Boise, ID (US); Scott E. Schaefer, Boise, ID (US); Anthony D. Veches, Boise, ID (US); Sujeet V. Ayyapureddi, Boise, ID (US); Randall J. Rooney, Boise, ID (US); Navid Lashkarian, Pleasanton, CA (US); Matthew A. Prather, Boise, ID (US)

(21) Appl. No.: 19/655,358

(22) Filed: Apr. 22, 2026

Related U.S. Application Data
(60) Provisional application No. 63/806,277, filed on May 15, 2025.

(51) Int. Cl. G06F 13/16

(52) U.S. Cl. CPC G06F 13/1689; G06F 13/1673

(57) ABSTRACT

Methods, systems, and devices for virtualized sideband bus within a memory system are described. A memory system may include a virtualized sideband channel between a sideband component and a registered clock driver (RCD). The virtualized sideband channel may be a bi-directional virtualized channel between one or more memory devices and the sideband component. For example, the one or more memory devices may exchange information with the RCD, and the RCD may exchange the information with the sideband component using the virtualized sideband channel. The RCD and the sideband component may communicate via the virtualized sideband channel during one or more time slots in which one or more in-band channels between the memory system and a host system are inactive.

### CROSS REFERENCE

The present Application for Patent claims priority to U.S. Patent Application No. 63/806,277 by Dover et al., entitled “VIRTUALIZED SIDEBAND BUS WITHIN MEMORY SYSTEM,” filed May. 15, 2025, which is assigned to the assignee hereof, and which is expressly incorporated by reference in its entirety herein.

### TECHNICAL FIELD

The following relates to one or more systems for memory, including virtualized sideband bus within a memory system.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIGS. 1 and 2 show examples of systems that support a virtualized sideband bus within a memory system in accordance with examples as disclosed herein.

FIG. 3 shows an example of a process flow that supports a virtualized sideband bus within a memory system in accordance with examples as disclosed herein.

FIG. 4 shows a block diagram of a memory system that supports a virtualized sideband bus within a memory system in accordance with examples as disclosed herein.

FIG. 5 shows a flowchart illustrating a method or methods that support a virtualized sideband bus within a memory system in accordance with examples as disclosed herein.

### DETAILED DESCRIPTION

A host system may communicate with a memory system using one or more in-band channels. For example, the host system may exchange access commands (e.g., read commands, write commands) and corresponding data with the memory system using a command/address (C/A) bus and a data bus that include one or more in-band channels. In some examples, a registered clock driver (RCD) of the memory system may buffer access commands and data from the one or more in-band channels and transmit the buffered access commands to one or more memory devices in the memory system, or vice versa (e.g., buffer data read from the memory devices before transmitting the data to the host system). Additionally, or alternatively, some memory systems may exchange information (e.g., control information, management information) with a baseboard management controller (BMC) via a sideband channel. In some examples, a sideband channel may be a channel used for exchanging information alongside primary data and command channels (e.g., in-band channels) of the memory system. For example, an in-band channel may refer to a channel that is used to convey data and command/address information between the host system and the memory system in accordance with one or more communication protocols. A sideband channel may refer to a channel (e.g., one or more separate channels or pins and/or one or more repurposed channels or pins) that is used to convey metadata, logging information, and other parameters that are supplemental to the data and command/address information for accesses by the host system. Such information exchanged via the sideband may improve performance and reliability of the memory system.

The BMC may be a controller within or otherwise coupled with a sideband component (e.g., a serial presence detect (SPD) module) of the memory system. The BMC may provide various management functions, such as monitoring a health status of the memory system (e.g., temperature, voltage, current), or managing a power state of the memory system (e.g., power on, off, reset, reboot), among other examples—even while the memory system is in a low-power state. The BMC may include or otherwise be coupled with BMC memory configured to store logging or health information associated with the memory system. In some examples, it may be desirable to increase a quantity of information exchanged with the BMC via the sideband channel. For example, increased information throughput may enable the BMC to more effectively manage the memory system. Additionally, it may be desirable to increase a width of the sideband channel to support an increased quantity of information or resources available to the BMC (e.g., to enable the BMC to more-directly access and communicate with the memory system resources rather than solely with the SPD). However, increasing a width of the sideband channel or adding additional sideband channels to the memory system may increase signaling overhead, chip complexity, manufacturing costs, and power consumption, among other examples. In some examples, the memory system may include one or more physical sideband connections to each memory device within the memory system in order to support direct logging of information from the memory devices to the BMC, which may increase overhead, manufacturing costs, chip complexity, and power consumption, among other examples.

Techniques described herein support a virtualized sideband channel between the sideband component and the RCD of the memory system that may enable increased throughput of sideband information with the BMC by supporting exchanges of information between the memory devices and the BMC without adding physical sideband connections to the memory devices. For example, each memory device in the memory system may be coupled with and operable to exchange data with the RCD. Accordingly, the described techniques include coupling the sideband component with the RCD and leveraging the RCD to facilitate exchanges of information over the sideband. The virtualized sideband channel may be a bi-directional virtualized channel between the one or more memory devices (e.g., via the RCD) and the sideband component. For example, the one or more memory devices may exchange information with the RCD, and the RCD may exchange the information with the sideband component using the virtualized sideband channel. In some examples, the RCD and the sideband component may communicate via the virtualized sideband channel during one or more time slots in which the one or more in-band channels are inactive. For example, the RCD may exchange signaling with the host system to either reserve bandwidth or otherwise receive an indication of available bandwidth (e.g., time slots) in which to exchange signaling through the virtualized sideband channel. The RCD may leverage the unused bandwidth from the in-band channels to instead exchange signaling with the sideband component during those time slots. In some examples, the virtualized sideband channel may be implemented using a communication link between the RCD and the sideband component. For example, the virtualized sideband channel may be implemented based on coupling one or more pins at the RCD with one or more pins at the sideband component. Thus, the virtualized sideband channel may support increased sideband information throughput without introducing an additional sideband channel that may otherwise increase signaling complexity and costs.

In addition to applicability in memory systems as described herein, techniques for a virtualized sideband bus within a memory system may be generally implemented to improve the performance and/or expand the access (e.g., information access, resource access) of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance and/or expand the access of electronic devices by implementing a virtualized sideband bus (e.g., a virtualized sideband channel), which may enable higher information throughput and performance relative to memory systems without the virtualized sideband bus, among other benefits.

Features of the disclosure are illustrated and described in the context of systems and architectures. Features of the disclosure are further illustrated and described in the context of a process flow and flowcharts.

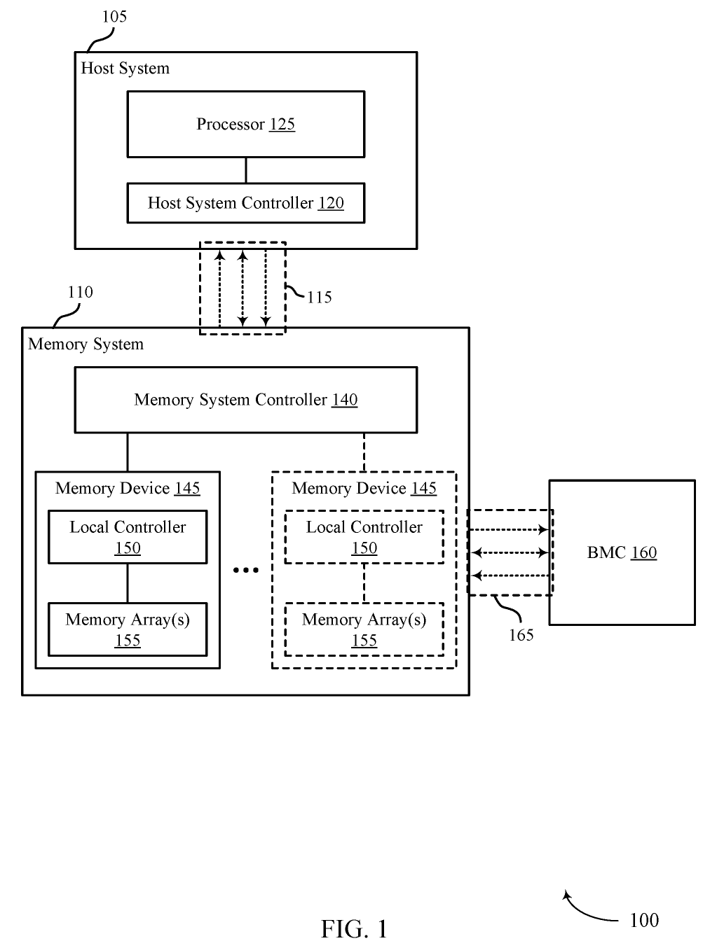

FIG. 1 shows an example of a system 100 that supports a virtualized sideband bus within a memory system in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110. The host system 105 may communicate with an RCD of the memory system 110 based on the CA channel. For example, the host system 105 may indicate, to the RCD, one or more time slots that one or more in-band channels, such as data channels, will be available (e.g., when there is available bandwidth in the one or more in-band channels). The in-band channel availability may be based on CA bus requests leading the data bus (e.g., data channel) activity. For example, the available bandwidth may be based on a duration between the CA bus requests and the data bus activity. Additionally, or alternatively, the host system 105 may communicate signaling (e.g., via one or more channels 115) with the RCD that indicates when the one or more time slots will occur in the data bus.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

In some systems 100, the host system 105 may communicate with the memory system 110 using one or more in-band channels (e.g., channels 115). For example, the host system 105 may exchange access commands (e.g., read commands, write commands) with the memory system 110 using a C/A bus that includes one or more in-band channels. In some examples, an RCD of the memory system 110 may buffer access commands from the one or more in-band channels and transmit the buffered access commands to one or more memory devices 145. Additionally, or alternatively, some memory systems 110 may exchange information (e.g., control information, management information) with a BMC 160 via a sideband channel 165. In some examples, the sideband channel 165 may be a channel used for exchanging information alongside primary data and command channels (e.g., in-band channels, the channels 115) of the memory system 110.

The BMC 160 may be a controller within or otherwise coupled with a sideband component (e.g., an SPD module) of the memory system 110. The BMC 160 may provide various management functions, such as monitoring a health status of the memory system 110 (e.g., temperature, voltage, current), or managing a power state of the memory system 110 (e.g., power on, off, reset, reboot), among other examples—even while the memory system 110 is in a low-power state. In some examples, it may be desirable to increase a quantity of information exchanged with the BMC 160 via the sideband channel 165. For example, increased information throughput may enable the BMC 160 to more effectively manage the memory system 110. However, increasing a width of the sideband channel (e.g., adding one or more additional I/O pins to the sideband component) or adding additional sideband channels to the memory system 110 may increase signaling overhead, chip complexity, manufacturing costs, and power consumption, among other examples.

Techniques described herein support a virtualized sideband channel between the sideband component and the RCD of the memory system 110 that may enable increased throughput of sideband information with the BMC 160. The virtualized sideband channel may be a bi-directional virtualized channel between the one or more memory devices 145 (e.g., via the RCD) and the sideband component. For example, the one or more memory devices 145 may exchange information with the RCD, and the RCD may exchange the information with the sideband component using the virtualized sideband channel. In some examples, the RCD and the sideband component may communicate via the virtualized sideband channel during one or more time slots in which the one or more in-band channels are inactive. For example, the RCD may obtain an indication of available bandwidth (e.g., time slots) in which to exchange signaling through the virtualized sideband channel based on communicating with the host system 105. In some examples, the virtualized sideband channel may be implemented using a communication link between the RCD and the sideband component. For example, the virtualized sideband channel may be implemented based on coupling one or more pins at the RCD with one or more pins at the sideband component.

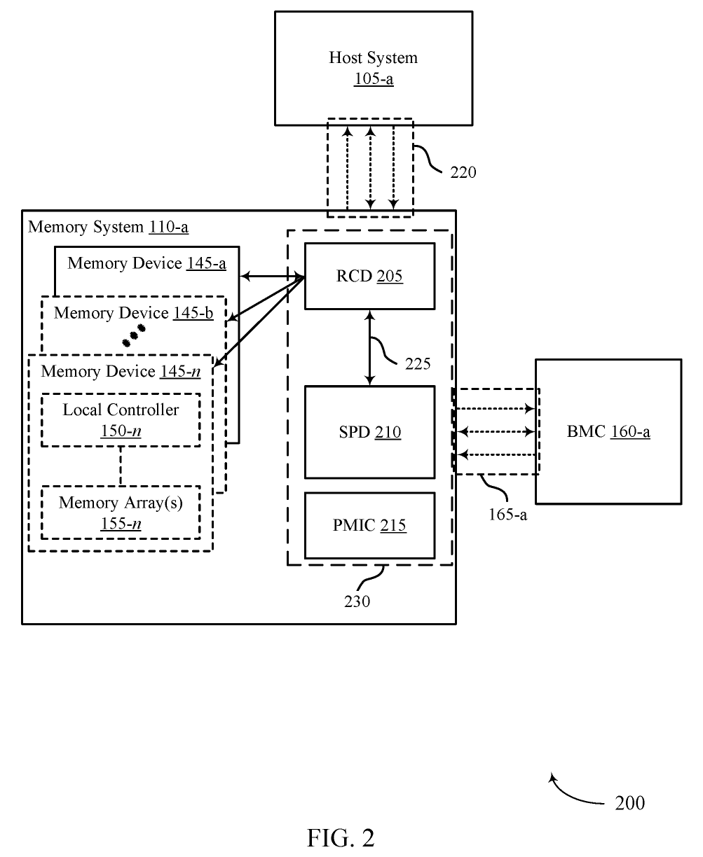

FIG. 2 shows an example of a system 200 that supports a virtualized sideband bus within a memory system in accordance with examples as disclosed herein. Aspects of the system 200 may implement, or be implemented by, aspects of the system 100 as described herein with reference to FIG. 1. For example, the system 200 may include a host system 105-a, a memory system 110-a, and a BMC 160-a, which may be examples of the host system 105, memory system 110, and BMC 160 described with reference to FIG. 1. The memory system 110-a may include one or more memory devices 145 (e.g., memory device 145-a, memory device 145-b, up to memory device 145-n), an RCD 205, an SPD module 210, and a power management integrated circuit (PMIC) 215. In some examples, one or more of the RCD 205, the SPD module 210, and the PMIC 215 may be included or otherwise configured to operate as a sideband component 230 (e.g., a “hub” for sideband communication with the BMC 160-a).

In some examples, the memory system 110-a may communicate with the host system 105-a via an in-band channel 220 (e.g., a channel 115 described with reference to FIG. 1). For example, the in-band channel 220 may be a C/A bus, a data bus, or both. The in-band channel 220 may be a channel that is used to convey data and command/address information between the host system 105-a and the memory system 110-a in accordance with one or more communication protocols. In some examples, the RCD 205 may facilitate signaling through the in-band channel 220. For example, the RCD 205 may receive one or more access commands from the in-band channel 220 and buffer the one or more access commands (e.g., in a command queue). In some examples, the RCD 205 may generate memory access signals (e.g., C/A signals) for the one or more memory devices 145 (e.g., for memory device 145-a, memory device 145-b). Based on performing an access command (e.g., transmitting an access command to a corresponding memory device 145), the RCD 205 may reduce the quantity of access commands in the buffer (e.g., the RCD 205 may reduce the command queue length). The RCD 205 may provide a predictable electrical load (e.g., for matching impedance, reactance, capacitance, etc.) to the host system 105-a, and may re-drive the memory access signals to the one or more memory devices 145.

In some examples, the PMIC 215 may manage a power (e.g., a voltage, a current, both) supplied to one or more portions of the memory system 110-a, including the memory devices 145. For example, the PMIC 215 may be coupled with a power input, may include logic circuitry for determining power to output to the memory system 110-a, and may include one or more switches (e.g., low dropout (LDO) switches) to output various powers to the memory system 110-a. In some cases, the PMIC 215 may be capable of outputting power via one or more power rails and according to one or more power modes (e.g., a pulse width modulation (PWM) mode, a phase frequency modulation (PFM) mode, or some other power mode), where different power modes may be associated with varying levels of performance at the memory system 110-a for different power levels. In some examples, the PMIC 215 may switch between power modes and provide different amounts of power to the memory system 110-a at different times according to host system estimations (e.g., predictions) of power usage by the memory system 110-a.

In addition to (or alternative to) the RCD 205, the PMIC 215, or both, the memory system 110-a may include the SPD module 210. The SPD module 210 may detect and log information that tracks various metrics of the one or more memory devices 145, such as error information, temperature information, memory device characteristic information, security information, diagnostic information, or the like. For example, the SPD module 210 may obtain measurements of data (e.g., metadata) stored at the memory device 145-a, the memory device 145-b, or both. In some examples, the memory device characteristic information may identify one or more characteristics of respective memory devices 145 of the memory system 110-a (e.g., speed, timing profiles, power consumption).

The sideband component 230 (e.g., a hub, a chip, an SoC) may include the RCD 205, the SPD module 210, the PMIC 215, or a combination thereof. The sideband component 230 may communicate the logged information with the BMC 160-a via a sideband channel 165-a. The sideband channel 165-a may refer to a first set of pins (e.g., I/O pins) of the memory system 110-a coupled with one or more pins of the BMC 160-a. A sideband channel may refer to a channel (e.g., one or more separate channels or pins and/or one or more repurposed channels or pins) that is used to convey metadata, logging information, and other parameters that are supplemental to the data and command/address information for accesses by the host system 105-a. Such information exchanged via the sideband may improve performance and reliability of the memory system 110-a, but may not always be necessary for baseline operation and execution of functions by the host system 105-a.

In some examples, the BMC 160-a may be a controller residing on a motherboard (e.g., external to the memory system 110) or a controller within (e.g., on a same module or board as) the memory system 110-a. In some cases, the BMC 160-a may be independent from the memory system 110-a and from the host system 105-a. The BMC 160-a may manage out-of-band tasks for the memory system 110-a, the host system 105-a, or both. For example, the BMC 160-a may monitor a health status (e.g., temperature, voltage, power supply status) of the memory system 110, record system events and errors (e.g., which may be used for troubleshooting and diagnostics), and implement firmware updates and security protocols (e.g., to protect the memory system 110-a and/or the memory devices 145 against unauthorized access), among other examples.

The BMC 160-a may perform the out-of-band tasks based on communicating sideband information with the sideband component 230 via the sideband channel 165-a. Communicating using the sideband channel 165-a may enable the memory system 110-a to avoid disrupting in-band communications (e.g., data communications) in the in-band channel 220 (e.g., to avoid interfering with communications with the host system 105-a). In some examples, it may be desirable to increase a throughput of information to the BMC 160-b via the sideband channel 165-a (e.g., to increase a management capability of the BMC 160-b). For example, a connection between the memory devices 145-a through 145-n with the BMC 160-a may be beneficial to log device-specific information. However, implementing an additional sideband channel 165, or expanding the sideband channel 165-a (e.g., from the BMC 160-a to the memory devices 145, including or skipping over the sideband component 230) may result in increased signaling overhead, manufacturing costs, and power consumption, such as increased physical pins and hardware connections at the memory devices 145, among other examples.

Accordingly, the techniques described herein enable a virtualized sideband channel 225 between the RCD 205 and the SPD module 210 (e.g., and/or between the RCD 205 and the sideband component 230), which may support a relatively higher throughput of information from the memory devices 145 to the BMC 160-a. For example, the RCD 205 may monitor a bandwidth of the in-band channel 220 and determine (e.g., detect) one or more time slots when the in-band channel 220 is available based on communication between the RCD 205 and the host system 105-a. In other words, the one or more time slots may refer to periods when the in-band channel 220 is idle or not fully occupied with command and address signals or other read and write data. During these periods (e.g., time slots), the RCD 205 may exchange sideband signaling with the SPD module 210 (e.g., with the sideband component 230) via the virtualized sideband channel 225. In some examples, the memory system 110-a may implement the virtualized sideband channel 225 using a second set of pins (e.g., I/O pins) at the RCD 205 and a third set of pins at the SPD module 210 (e.g., and/or the sideband component 230). For example, the RCD 205 may exchange the sideband signaling with the SPD module 210 using one or more pins at the RCD 205 that are coupled with one or more pins at the SPD module 210.

In some cases, the RCD 205 may buffer the sideband signaling in a buffer until one or more time slots become available in the in-band channel 220, and communicate the sideband signaling during the one or more time slots. The RCD 205 may communicate signaling (e.g., via the in-band channel 220) with the host system 105-a that indicates when there is available bandwidth in the in-band channel 220. In some examples, the host system 105-a may transmit one or more indications to the RCD 205 when there is or will be available bandwidth in the in-band channel 220. Additionally, or alternatively, the RCD 205 may transmit one or more messages that indicate the RCD 205 has sideband data to transmit and that request the host system 105-a to pause communications via the in-band channel 220 for at least a time period. In some examples, the RCD 205 may indicate when the one or more time slots will occur to the SPD module 210 based on communicating with the host system 105-a (e.g., to coordinate signaling, to prepare the SPD module 210 to receive the sideband signaling).

The virtualized sideband channel 225 may be a bi-directional link. For example, the RCD 205 may read information from the memory devices 145 and forward the information to the SPD module 210 using the virtualized sideband channel 225. The sideband component 230 may communicate the information to the BMC 160-a using the sideband channel 165-a. Additionally, or alternatively, the RCD 205 may receive information from the SPD module 210 (e.g., information received by the sideband component 230 from the BMC 160-a) and write the information to the memory devices 145. The virtualized sideband channel 225 may be referred to as “virtualized” because the virtualized sideband channel 225 may provide a link between the BMC 160-a and the one or more memory devices 145 without adding additional physical connections or hardware to the one or more memory devices 145. That is, the connection between the memory devices 145 and the RCD 205 may be established for in-band communication, and may be repurposed during available time slots to convey sideband information, such that the connection may be considered “virtualized.”

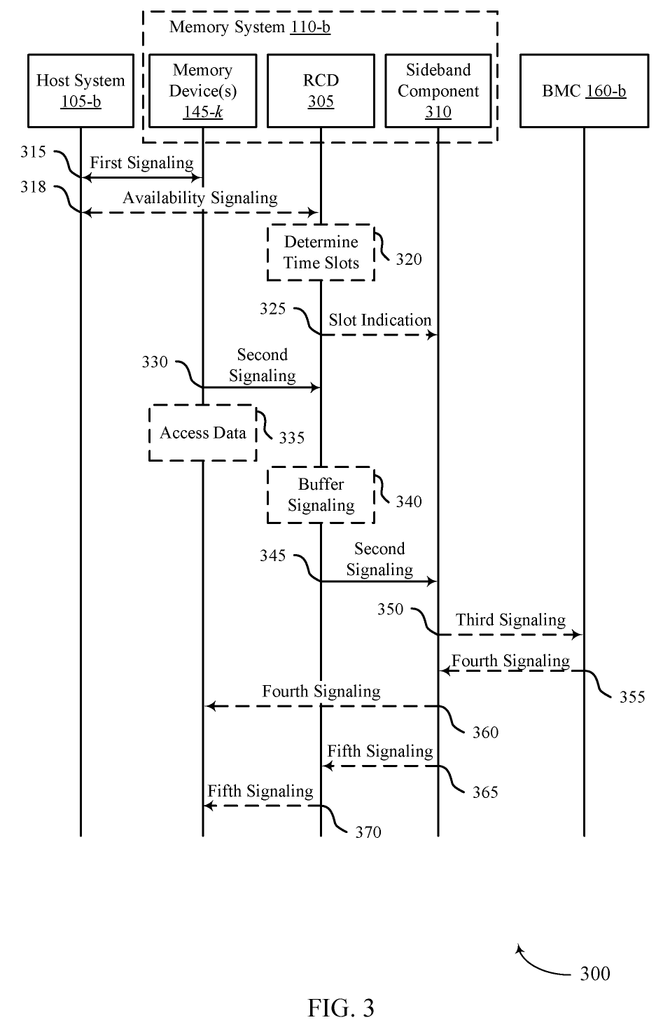

FIG. 3 shows an example of a process flow 300 that supports a virtualized sideband bus within a memory system in accordance with examples as disclosed herein. The process flow 300 may be implemented by aspects of the system 100 or the system 200, as described with reference to FIGS. 1 and 2. For example, the process flow 300 may be implemented by a host system 105-b and a memory system 110-b, which may be examples of the host system 105 and the memory system 110 as described with reference to FIG. 1. The memory system 110-b may include one or more memory devices 145-k (e.g., up to a k quantity of memory devices), an RCD 305 (e.g., RCD 205 described with reference to FIG. 2), and a sideband component 310 (e.g., sideband component 230), among other components. In some examples, the sideband component 310 may include an SPD module, a PMIC, the RCD 305, or any combination thereof. The process flow 300 may be an example of a process flow for the memory system 110-b to communicate with a BMC 160-b using a virtualized sideband channel between the RCD 305 and the sideband component 310.

In the following description of the process flow 300, the operations may be performed in a different order than the order shown, or other operations may be added or removed from the process flow 300. For example, some operations may be left out of the process flow 300, may be performed in different orders or at different times, or other operations may be added to the process flow 300. Although a memory system 110-b, a host system 105-b, and a BMC 160-b may perform the operations of the process flow 300, some aspects of some operations may also be performed by one or more other memory systems, memory devices, host devices, BMCs, controllers, or other electronic devices (e.g., as described herein with respect to FIG. 1).

At 315, the memory system 110-b may communicate first signaling with the host system 105-b via an in-band channel (e.g., a C/A bus, a data bus) configured for communication between the memory system 110-b and the host system 105-b in accordance with the RCD 305. In some examples, the memory system 110-b may communicate the first signaling, via the RCD 305, between the one or more memory devices 145-k within the memory system 110-b and the in-band channel. For example, the host system 105-b may request data using one or more read commands from the one or more memory devices 145-k, and the memory system 110-b may communicate, via the RCD 305 and the in-band channel, the requested data from one or more of the memory devices 145-k based on the one or more read commands. In another example, the host system 105-b may issue one or more write commands to the one or more memory devices 145-k, and the memory system 110-b may write data corresponding to the one or more write commands to the one or more memory devices 145-k via the RCD 305 and the in-band channel.

At 318, the RCD 305 may communicate with the host system 105-b to determine one or more time slots in which at least a portion of the in-band channel is available. For example, the RCD 305 may receive an indication of the one or more time slots based on one or more parameters associated with the in-band channel. The one or more parameters may include a command queue length of the RCD 305 (e.g., a queue of commands for the RCD 305 to execute, a queue of commands received via the in-band channel), a bandwidth availability (e.g., an unused capacity) of the in-band channel, a quantity of access commands for the one or more memory devices 145-k, or any combination thereof. In some cases, the RCD 305 may receive the indication based on transmitting a request message to the host system 105-b (e.g., a request for the bandwidth availability, a request for the one or more time slots).

At 320, the RCD 305 may determine the one or more time slots in which at least a portion of the in-band channel is available based on communicating the first signaling, based on communicating with the host system 105-b, or both. For example, the RCD 305 may determine one or more time slots between consecutive access commands in which the in-band channel is inactive (e.g., the host system 105-b may confirm or otherwise indicate that the in-band channel may remain inactive during the one or more time slots). At 325, the RCD 305 may transmit an indication of the one or more time slots (e.g., an indication of the determined time slots, an indication of the indicated time slots) to the sideband component 310 based on determining the one or more time slots or receiving an indication of the one or more time slots.

In some examples, the in-band channel may support a first bandwidth associated with a maximum amount of data conveyed via the in-band channel at a given time. The virtualized sideband channel may include at least a portion of the first bandwidth of the in-band channel based on the virtualized sideband channel being used during the one or more time slots in which at least the portion of the in-band channel is available. In some examples, the in-band channel may include a data bus, a C/A bus, or both associated with accommodating bi-directional signaling via the virtualized sideband channel during the one or more time slots in which at least the portion of the in-band channel is available.

At 330, the RCD 305 may receive second signaling from the one or more memory devices 145-k. Additionally, or alternatively, the RCD 305 may transmit the second signaling from the one or more memory devices 145-k (e.g., based on a bi-directionality of the virtualized sideband channel). In some examples, the second signaling may be associated with the BMC 160-b (e.g., the BMC 160-b coupled with the memory system 110-b). In some examples, the memory system 110-b may obtain one or more measurements of data stored at the one or more memory devices 145-k, and the second signaling may include the one or more measurements. The information conveyed via the second signaling may include, for example, error information associated with the memory devices 145, temperature information for the memory devices, access frequency information for the memory devices, other logging metrics associated with the memory devices, commands for temperature operations, error correction operations, or refresh management operations to be performed by the memory devices 145, or any combination thereof. Additionally, or alternatively, the second signaling may convey main memory content(e.g., read data, write data) of the one or more memory devices 145-k via the virtualized sideband channel.

At 335, the memory system 110-b may access first data stored at the one or more memory devices 145-k in accordance with one or more access commands included in the first signaling exchanged via the in-band channel. For example, the memory system 110-b may read data from the one or more memory devices 145-k based on receiving one or more read commands and the memory system 110-b may write data to the one or more memory devices 145-k based on receiving one or more write commands.

Additionally, or alternatively, the memory system 110-b may access second data stored at the one or more memory devices 145-k in accordance with the second signaling exchanged via a sideband channel (e.g., the virtualized sideband channel between the RCD 305 and the sideband component 310, the sideband channel between the sideband component 310 and the BMC 160-b) for information logging with the memory system 110-b. In some examples, the second data may include metadata associated with one or more parameters of the one or more memory devices 145-k. For example, the metadata may include characteristic information, management information, security information, diagnostic information, or any combination thereof corresponding to the one or more memory devices 145-k.

At 340, the RCD 305 may store the second signaling (e.g., or at least a portion of the second signaling) at a buffer of the memory system 110-b (e.g., a buffer of the RCD 305). In some examples, the second signaling may include the second data. The RCD 305 may store the second signaling at the buffer until the one or more time slots are available.

At 345, the RCD 305 may transmit the second signaling to the sideband component 310 via the virtualized sideband channel during the one or more time slots. For example, the RCD 305 may transmit the second signaling based on transmitting the indication of the one or more time slots (e.g., which may prepare the sideband component 310 to receive the second signaling). Additionally, or alternatively, the RCD 305 may transmit the second signaling based on storing the second signaling at the buffer (e.g., the RCD 305 may transmit the buffered portions of the second signaling during the one or more available time slots). In some examples, the virtualized sideband channel may be based on a communication link between one or more pins of the RCD 305 and one or more pins of the sideband component 310. In other words, one or more pins of the RCD 305 may be coupled with one or more pins of the sideband component 310 to implement the virtualized sideband channel. In some examples, the sideband component 310 may be coupled with the BMC 160-b via a sideband channel.

At 350, the sideband component 310 may transmit third signaling to the BMC 160-b via the sideband channel. In some examples, the third signaling may be based on the second signaling. For example, the third signaling may include the second signaling or information from the second signaling (e.g., forwarding the second signaling). The memory system 110-b may adjust one or more parameters of the memory system 110-b based on transmitting the third signaling to the BMC 160-b (e.g., the BMC 160-b may indicate the memory system 110-b to adjust the one or more parameters based on the third signaling). For example, the memory system 110-b may adjust one or more voltages of the memory system 110-b, one or more power modes of the memory system 110-b (e.g., via the PMIC 215), or one or more security settings of the memory system, among other examples. At 355, the sideband component 310 may receive, from the BMC 160-b via the sideband channel, fourth signaling in response to the third signaling. For example, the fourth signaling may include an indication to adjust the one or more parameters. Additionally, or alternatively, adjusting the one or more parameters may include accessing memory content (e.g., read data, write data) stored at the one or more memory devices 145-k.

At 360, the sideband component 310 may forward the fourth signaling to the one or more memory devices 145-k via the virtualized sideband channel. For example, the sideband component 310 may transmit the fourth signaling to the RCD 305 (e.g., during one or more available time slots in the in-band channel), and the RCD 305 may transmit the fourth signaling to the one or more memory devices 145-k. In some examples, the memory system 110-b may adjust the one or more parameters based on the fourth signaling.

At 365, the RCD 305 may receive fifth signaling from the sideband component 310 via the virtualized sideband channel during one or more second time slots in which at least a portion of the in-band channel is available. The fifth signaling may include data to be written to the one or more memory devices 145-k. At 370, the RCD 305 may transmit the fifth signaling to the one or more memory devices 145-k.

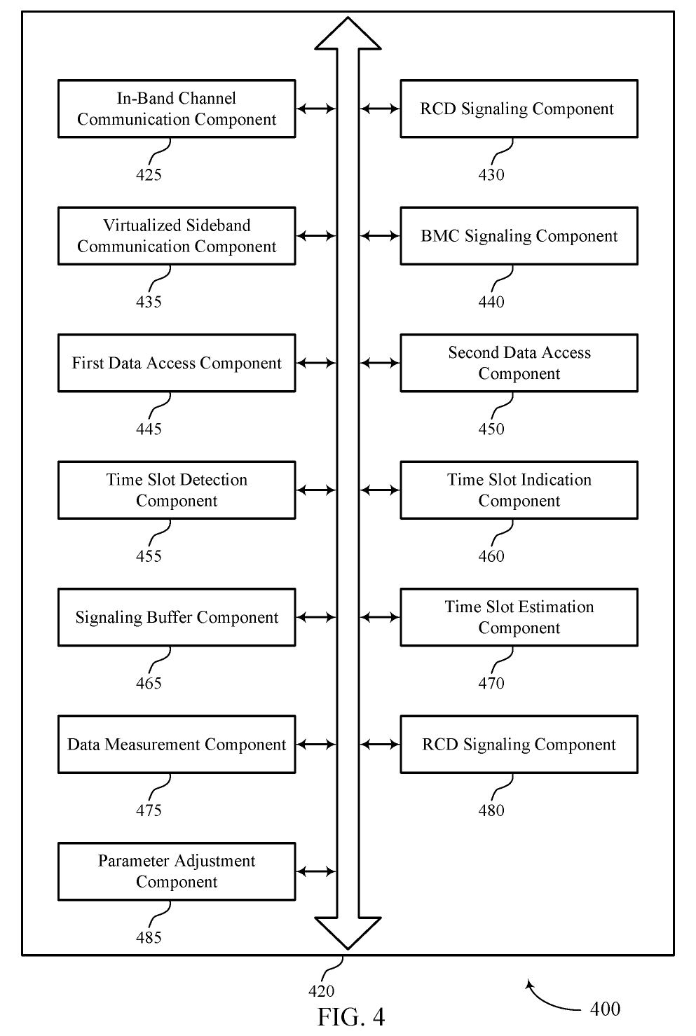

FIG. 4 shows a block diagram 400 of a memory system 420 that supports a virtualized sideband bus within a memory system in accordance with examples as disclosed herein. The memory system 420 may be an example of aspects of a memory system as described with reference to FIGS. 1 through 3. The memory system 420, or various components thereof, may be an example of means for performing various aspects of virtualized sideband bus within a memory system as described herein. For example, the memory system 420 may include an in-band channel communication component 425, an RCD signaling component 430, a virtualized sideband communication component 435, an BMC signaling component 440, a first data access component 445, a second data access component 450, a time slot detection component 455, a time slot indication component 460, a signaling buffer component 465, a time slot estimation component 470, a data measurement component 475, an RCD signaling component 480, a parameter adjustment component 485, or any combination thereof. Each of these components, or components of subcomponents thereof (e.g., one or more processors, one or more memories), may communicate, directly or indirectly, with one another (e.g., via one or more buses).

The in-band channel communication component 425 may be configured as or otherwise support a means for communicating, via an in-band channel configured for communication between the memory system and a host system coupled with the memory system and in accordance with a registered clock driver of the memory system, first signaling, where the first signaling is communicated, via the registered clock driver, between one or more memory devices within the memory system and the in-band channel. The RCD signaling component 430 may be configured as or otherwise support a means for receiving, by the registered clock driver and from the one or more memory devices, second signaling associated with a baseboard management controller coupled with the memory system. The virtualized sideband communication component 435 may be configured as or otherwise support a means for transmitting, by the registered clock driver during one or more time slots in which at least a portion of the in-band channel is available, the second signaling to a sideband component of the memory system via a virtualized sideband channel, where the sideband component is coupled with the baseboard management controller via a sideband channel.

In some examples, the BMC signaling component 440 may be configured as or otherwise support a means for transmitting third signaling from the sideband component to the baseboard management controller via the sideband channel, the third signaling based at least in part on the second signaling. In some examples, the parameter adjustment component 485 may be configured as or otherwise support a means for adjusting one or more parameters of the memory system based at least in part on transmitting the third signaling to the baseboard management controller.

In some examples, the BMC signaling component 440 may be configured as or otherwise support a means for receiving, by the sideband component from the baseboard management controller via the sideband channel, fourth signaling in response to the third signaling. In some examples, the virtualized sideband communication component 435 may be configured as or otherwise support a means for forwarding the fourth signaling to the one or more memory devices via the virtualized sideband channel. In some examples, the parameter adjustment component 485 may be configured as or otherwise support a means for adjusting one or more parameters of the memory system based at least in part on the fourth signaling.

In some examples, the first data access component 445 may be configured as or otherwise support a means for accessing first data stored at the one or more memory devices in accordance with one or more access commands included in the first signaling exchanged via the in-band channel. In some examples, the second data access component 450 may be configured as or otherwise support a means for accessing second data stored at the one or more memory devices in accordance with the second signaling exchanged via the sideband channel for information logging associated with the memory system, where the second data includes metadata associated with one or more parameters of the one or more memory devices. In some examples, the metadata includes characteristic information, management information, security information, diagnostic information, or any combination thereof associated with the one or more memory devices.

In some examples, the time slot detection component 455 may be configured as or otherwise support a means for detecting, at the registered clock driver, the one or more time slots based at least in part on communicating the first signaling. In some examples, the time slot indication component 460 may be configured as or otherwise support a means for transmitting an indication of the one or more time slots to the sideband component based at least in part on the one or more time slots, where transmitting the second signaling is based at least in part on transmitting the indication.

In some examples, the signaling buffer component 465 may be configured as or otherwise support a means for storing the second signaling at a buffer associated with the registered clock driver until the one or more time slots are available, where transmitting the second signaling is based at least in part on storing the second signaling at the buffer.

In some examples, the time slot estimation component 470 may be configured as or otherwise support a means for receiving, by the registered clock driver, an indication of the one or more time slots from the host system based at least in part on one or more parameters associated with the in-band channel. In some examples, the one or more parameters include a command queue length of the registered clock driver, a bandwidth availability of the in-band channel, a quantity of access commands for the one or more memory devices, or any combination thereof. In some examples, the data measurement component 475 may be configured as or otherwise support a means for obtaining one or more measurements of data stored at the one or more memory devices, where the second signaling includes the one or more measurements.

In some examples, the RCD signaling component 480 may be configured as or otherwise support a means for receiving, by the registered clock driver and from the sideband component via the virtualized sideband channel during one or more second time slots in which at least a portion of the in-band channel is available, third signaling including data to be written to the one or more memory devices. In some examples, the virtualized sideband communication component 435 may be configured as or otherwise support a means for transmitting, by the registered clock driver, the third signaling to the one or more memory devices via the virtualized sideband channel.

In some examples, the in-band channel supports a first bandwidth associated with a maximum amount of data conveyed via the in-band channel at a given time. In some examples, the virtualized sideband channel includes at least a portion of the first bandwidth of the in-band channel based at least in part on the virtualized sideband channel being used during the one or more time slots in which at least the portion of the in-band channel is available.

In some examples, the in-band channel includes a data bus, a command/address bus, or both associated with accommodating bi-directional signaling via the virtualized sideband channel during the one or more time slots in which at least the portion of the in-band channel is available. In some examples, the virtualized sideband channel is based at least in part on a communication link between one or more pins of the registered clock driver and one or more pins of the sideband component. In some examples, the sideband component includes a serial presence detect module, a power management integrated circuit, the registered clock driver, or any combination thereof.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

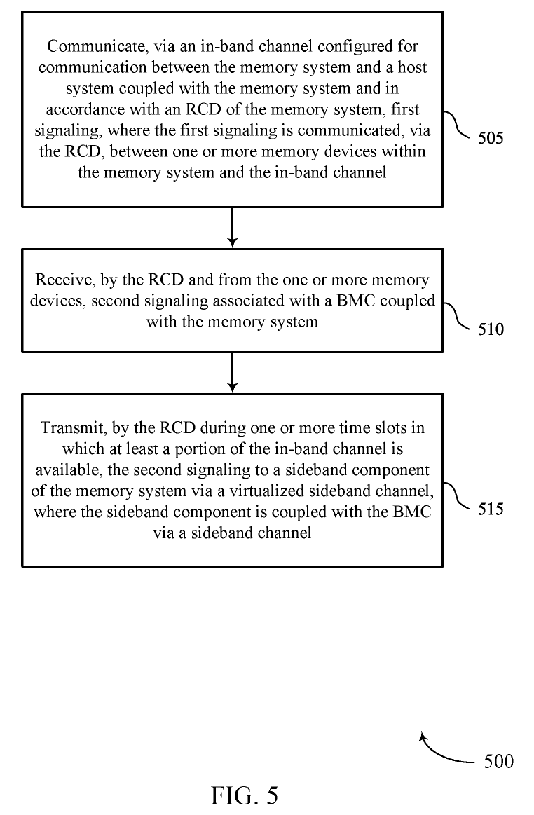

FIG. 5 shows a flowchart illustrating a method 500 that supports a virtualized sideband bus within a memory system in accordance with examples as disclosed herein. The operations of method 500 may be implemented by a memory system or its components as described herein. For example, the operations of method 500 may be performed by a memory system as described with reference to FIGS. 1-4. In some examples, a memory system may execute a set of instructions to control the functional elements of the device to perform the described functions. Additionally, or alternatively, the memory system may perform aspects of the described functions using special-purpose hardware.

At 505, the method may include communicating, via an in-band channel configured for communication between the memory system and a host system coupled with the memory system and in accordance with a registered clock driver of the memory system, first signaling, where the first signaling is communicated, via the registered clock driver, between one or more memory devices within the memory system and the in-band channel. In some examples, aspects of the operations of 505 may be performed by an in-band channel communication component 425 as described with reference to FIG. 4.

At 510, the method may include receiving, by the registered clock driver and from the one or more memory devices, second signaling associated with a baseboard management controller coupled with the memory system. In some examples, aspects of the operations of 510 may be performed by an RCD signaling component 430 as described with reference to FIG. 4.

At 515, the method may include transmitting, by the registered clock driver during one or more time slots in which at least a portion of the in-band channel is available, the second signaling to a sideband component of the memory system via a virtualized sideband channel, where the sideband component is coupled with the baseboard management controller via a sideband channel. In some examples, aspects of the operations of 515 may be performed by a virtualized sideband communication component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for communicating, via an in-band channel configured for communication between the memory system and a host system coupled with the memory system and in accordance with an RCD of the memory system, first signaling, where the first signaling is communicated, via the RCD, between one or more memory devices within the memory system and the in-band channel; receiving, by the RCD and from the one or more memory devices, second signaling associated with a BMC coupled with the memory system; and transmitting, by the RCD during one or more time slots in which at least a portion of the in-band channel is available, the second signaling to a sideband component of the memory system via a virtualized sideband channel, where the sideband component is coupled with the BMC via a sideband channel.

Aspect 2: The method, apparatus, or non-transitory computer-readable medium of aspect 1, further including operations, features, circuitry, logic, means, or instructions, or any combination thereof for transmitting third signaling from the sideband component to the BMC via the sideband channel, the third signaling based at least in part on the second signaling.

Aspect 3: The method, apparatus, or non-transitory computer-readable medium of aspect 2, further including operations, features, circuitry, logic, means, or instructions, or any combination thereof for adjusting one or more parameters of the memory system based at least in part on transmitting the third signaling to the BMC.

Aspect 4: The method, apparatus, or non-transitory computer-readable medium of aspect 2, further including operations, features, circuitry, logic, means, or instructions, or any combination thereof for receiving, by the sideband component from the BMC via the sideband channel, fourth signaling in response to the third signaling; forwarding the fourth signaling to the one or more memory devices via the virtualized sideband channel; and adjusting one or more parameters of the memory system based at least in part on the fourth signaling.

Aspect 5: The method, apparatus, or non-transitory computer-readable medium of any of aspects 1 through 4, further including operations, features, circuitry, logic, means, or instructions, or any combination thereof for accessing first data stored at the one or more memory devices in accordance with one or more access commands included in the first signaling exchanged via the in-band channel and accessing second data stored at the one or more memory devices in accordance with the second signaling exchanged via the sideband channel for information logging associated with the memory system, where the second data includes metadata associated with one or more parameters of the one or more memory devices.

Aspect 6: The method, apparatus, or non-transitory computer-readable medium of aspect 5, where the metadata includes characteristic information, management information, security information, diagnostic information, or any combination thereof associated with the one or more memory devices.

Aspect 7: The method, apparatus, or non-transitory computer-readable medium of any of aspects 1 through 6, further including operations, features, circuitry, logic, means, or instructions, or any combination thereof for detecting, at the RCD, the one or more time slots based at least in part on communicating the first signaling and transmitting an indication of the one or more time slots to the sideband component based at least in part on detecting the one or more time slots, where transmitting the second signaling is based at least in part on transmitting the indication.

Aspect 8: The method, apparatus, or non-transitory computer-readable medium of any of aspects 1 through 7, further including operations, features, circuitry, logic, means, or instructions, or any combination thereof for storing the second signaling at a buffer associated with the RCD until the one or more time slots are available, where transmitting the second signaling is based at least in part on storing the second signaling at the buffer.

Aspect 9: The method, apparatus, or non-transitory computer-readable medium of any of aspects 1 through 8, further including operations, features, circuitry, logic, means, or instructions, or any combination thereof for estimating, by the RCD, the one or more time slots based at least in part on one or more parameters associated with the in-band channel.

Aspect 10: The method, apparatus, or non-transitory computer-readable medium of aspect 9, where the one or more parameters include a command queue length of the RCD, a bandwidth availability of the in-band channel, a quantity of access commands for the one or more memory devices, or any combination thereof.

Aspect 11: The method, apparatus, or non-transitory computer-readable medium of any of aspects 1 through 10, further including operations, features, circuitry, logic, means, or instructions, or any combination thereof for obtaining one or more measurements of data stored at the one or more memory devices, where the second signaling includes the one or more measurements.

Aspect 12: The method, apparatus, or non-transitory computer-readable medium of any of aspects 1 through 11, further including operations, features, circuitry, logic, means, or instructions, or any combination thereof for receiving, by the RCD and from the sideband component via the virtualized sideband channel during one or more second time slots in which at least a portion of the in-band channel is available, third signaling including data to be written to the one or more memory devices and transmitting, by the RCD, the third signaling to the one or more memory devices via the virtualized sideband channel.

Aspect 13: The method, apparatus, or non-transitory computer-readable medium of any of aspects 1 through 12, where the in-band channel supports a first bandwidth associated with a maximum amount of data conveyed via the in-band channel at a given time and the virtualized sideband channel includes at least a portion of the first bandwidth of the in-band channel based at least in part on the virtualized sideband channel being used during the one or more time slots in which at least the portion of the in-band channel is available.

Aspect 14: The method, apparatus, or non-transitory computer-readable medium of any of aspects 1 through 13, where the in-band channel includes a data bus, a C/A bus, or both associated with accommodating bi-directional signaling via the virtualized sideband channel during the one or more time slots in which at least the portion of the in-band channel is available.

Aspect 15: The method, apparatus, or non-transitory computer-readable medium of any of aspects 1 through 14, where the virtualized sideband channel is based at least in part on a communication link between one or more pins of the RCD and one or more pins of the sideband component.

Aspect 16: The method, apparatus, or non-transitory computer-readable medium of any of aspects 1 through 15, where the sideband component includes an SPD module, a PMIC, the RCD, or any combination thereof.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memories storing processor-executable code; and
one or more processors coupled with the one or more memories and individually or collectively operable to execute the code to cause the memory system to:
communicate, via an in-band channel configured for communication between the memory system and a host system coupled with the memory system and in accordance with a registered clock driver of the memory system, first signaling, wherein the first signaling is communicated, via the registered clock driver, between one or more memory devices within the memory system and the in-band channel;
receive, by the registered clock driver and from the one or more memory devices, second signaling associated with a baseboard management controller coupled with the memory system; and
transmit, by the registered clock driver during one or more time slots in which at least a portion of the in-band channel is available, the second signaling to a sideband component of the memory system via a virtualized sideband channel, wherein the sideband component is coupled with the baseboard management controller via a sideband channel.

2. The memory system of claim 1, wherein the one or more processors are individually or collectively further operable to execute the code to cause the memory system to:
receive, by the registered clock driver from the host system, an indication of the one or more time slots based at least in part on one or more parameters associated with the in-band channel.

3. The memory system of claim 2, wherein the one or more parameters comprise a command queue length of the registered clock driver, a bandwidth availability of the in-band channel, a quantity of access commands for the one or more memory devices, or any combination thereof.

4. The memory system of claim 1, wherein the one or more processors are individually or collectively further operable to execute the code to cause the memory system to:
transmit third signaling from the sideband component to the baseboard management controller via the sideband channel, the third signaling based at least in part on the second signaling.

5. The memory system of claim 4, wherein the one or more processors are individually or collectively further operable to execute the code to cause the memory system to:
adjust one or more parameters of the memory system based at least in part on transmitting the third signaling to the baseboard management controller.

6. The memory system of claim 4, wherein the one or more processors are individually or collectively further operable to execute the code to cause the memory system to:
receive, by the sideband component from the baseboard management controller via the sideband channel, fourth signaling in response to the third signaling;
forward the fourth signaling to the one or more memory devices via the virtualized sideband channel; and
adjust one or more parameters of the memory system based at least in part on the fourth signaling.

7. The memory system of claim 1, wherein the one or more processors are individually or collectively further operable to execute the code to cause the memory system to:
access first data stored at the one or more memory devices in accordance with one or more access commands included in the first signaling exchanged via the in-band channel; and
access second data stored at the one or more memory devices in accordance with the second signaling exchanged via the sideband channel for information logging associated with the memory system, wherein the second data comprises metadata associated with one or more parameters of the one or more memory devices.

8. The memory system of claim 7, wherein the metadata comprises characteristic information, management information, security information, diagnostic information, or any combination thereof associated with the one or more memory devices.

9. The memory system of claim 1, wherein the one or more processors are individually or collectively further operable to execute the code to cause the memory system to:
transmit an indication of the one or more time slots to the sideband component based at least in part on the one or more time slots, wherein transmitting the second signaling is based at least in part on transmitting the indication.

10. The memory system of claim 1, wherein the one or more processors are individually or collectively further operable to execute the code to cause the memory system to:
store the second signaling at a buffer associated with the registered clock driver until the one or more time slots are available, wherein transmitting the second signaling is based at least in part on storing the second signaling at the buffer.

11. The memory system of claim 1, wherein the one or more processors are individually or collectively further operable to execute the code to cause the memory system to:
obtain one or more measurements of data stored at the one or more memory devices, wherein the second signaling comprises the one or more measurements.

12. The memory system of claim 1, wherein the one or more processors are individually or collectively further operable to execute the code to cause the memory system to:
receive, by the registered clock driver and from the sideband component via the virtualized sideband channel during one or more second time slots in which at least a portion of the in-band channel is available, third signaling comprising data to be written to the one or more memory devices; and
transmit, by the registered clock driver, the third signaling to the one or more memory devices.

13. The memory system of claim 1, wherein:
the in-band channel supports a first bandwidth associated with a maximum amount of data conveyed via the in-band channel at a given time, and
the virtualized sideband channel comprises at least a portion of the first bandwidth of the in-band channel based at least in part on the virtualized sideband channel being used during the one or more time slots in which at least the portion of the in-band channel is available.

14. The memory system of claim 1, wherein the in-band channel comprises a data bus, a command/address bus, or both associated with accommodating bi-directional signaling via the virtualized sideband channel during the one or more time slots in which at least the portion of the in-band channel is available.

15. The memory system of claim 1, wherein the virtualized sideband channel is based at least in part on a communication link between one or more pins of the registered clock driver and one or more pins of the sideband component.

16. The memory system of claim 1, wherein the sideband component comprises a serial presence detect module, a power management integrated circuit, the registered clock driver, or any combination thereof.

17. A method by a memory system, comprising:
communicating, via an in-band channel configured for communication between the memory system and a host system coupled with the memory system and in accordance with a registered clock driver of the memory system, first signaling, wherein the first signaling is communicated, via the registered clock driver, between one or more memory devices within the memory system and the in-band channel;
receiving, by the registered clock driver and from the one or more memory devices, second signaling associated with a baseboard management controller coupled with the memory system; and
transmitting, by the registered clock driver during one or more time slots in which at least a portion of the in-band channel is available, the second signaling to a sideband component of the memory system via a virtualized sideband channel, wherein the sideband component is coupled with the baseboard management controller via a sideband channel.

18. The method of claim 17, further comprising:
transmitting third signaling from the sideband component to the baseboard management controller via the sideband channel, the third signaling based at least in part on the second signaling.

19. The method of claim 17, further comprising:
transmitting an indication of the one or more time slots to the sideband component based at least in part on the one or more time slots, wherein transmitting the second signaling is based at least in part on transmitting the indication.

20. The method of claim 17, further comprising:
receiving, by the registered clock driver and from the sideband component via the virtualized sideband channel during one or more second time slots in which at least a portion of the in-band channel is available, third signaling comprising data to be written to the one or more memory devices; and
transmitting, by the registered clock driver, the third signaling to the one or more memory devices.

21. A non-transitory computer-readable medium storing code, the code comprising instructions executable by one or more processors to:
communicate, via an in-band channel configured for communication between a memory system and a host system coupled with the memory system and in accordance with a registered clock driver of the memory system, first signaling, wherein the first signaling is communicated, via the registered clock driver, between one or more memory devices within the memory system and the in-band channel;
receive, by the registered clock driver and from the one or more memory devices, second signaling associated with a baseboard management controller coupled with the memory system; and
transmit, by the registered clock driver during one or more time slots in which at least a portion of the in-band channel is available, the second signaling to a sideband component of the memory system via a virtualized sideband channel, wherein the sideband component is coupled with the baseboard management controller via a sideband channel.

22. The non-transitory computer-readable medium of claim 21, wherein the instructions are further executable by the one or more processors to:
transmit third signaling from the sideband component to the baseboard management controller via the sideband channel, the third signaling based at least in part on the second signaling.

23. The non-transitory computer-readable medium of claim 21, wherein the instructions are further executable by the one or more processors to:
transmit an indication of the one or more time slots to the sideband component based at least in part on the one or more time slots, wherein transmitting the second signaling is based at least in part on transmitting the indication.

24. The non-transitory computer-readable medium of claim 21, wherein the instructions are further executable by the one or more processors to:
receive, by the registered clock driver and from the sideband component via the virtualized sideband channel during one or more second time slots in which at least a portion of the in-band channel is available, third signaling comprising data to be written to the one or more memory devices; and
transmit, by the registered clock driver, the third signaling to the one or more memory devices.
